(19) United States
(12) Patent Application Publication
(10) Pub. No.: US 2017/0154379 A1
(43) Pub. Date: Jun. 1, 2017

(54) A NOVEL SYSTEM FOR THE VALUATION AND SALES OF IMMOVABLE PROPERTIES

(71) Applicant: INANLAR INSAAT ANONIM SIRKETI, ISTANBUL (TR)

(72) Inventor: SERDAR INAN, ISTANBUL (TR)

(73) Assignee: INANLAR INSAAT ANONIM SIRKETI, ISTANBUL (TR)

(21) Appl. No.: 15/320,752

(22) PCT Filed: May 28, 2015
(86) PCT No.: PCT/TR2015/000240

§ 371 Date: Dec. 21, 2016

(30) Foreign Application Priority Data
Jul. 8, 2014 (TR) 2014/08004

(51) Int. Cl. G06Q 40/02; G06Q 30/02; G06Q 50/16; G06Q 40/08

(52) U.S. Cl. CPC G06Q 40/025; G06Q 40/08; G06Q 30/0279; G06Q 50/167

(57) ABSTRACT

A method and system wherein the bare ownership (1a) and the right of use (1b) of an immovable property (1) are treated separately so that a buyer can posses the immovable property (1) until the end of his/her life at lower costs, and wherein the bare ownership (1a) and the right of use (1b) of the immovable property are optionally used as separate commercial and investment tools. In performing the system, the right of use (1b) of the immovable (1) is sold at lower prices as the age of the buyers (3) increases.

### CROSS REFERENCE TO RELATED APPLICATIONS

This application is the national phase entry of International Application No. PCT/TR2015/000240, filed on May 28, 2015, which is based upon and claims priority to Turkish Patent Application No. 2014/08004, filed on Jul. 8, 2014, the entire contents of which are incorporated herein by reference.

### TECHNICAL FIELD

The present invention relates to a novel method of providing credit or loan for immovable properties and to a novel system wherein this method is implemented. The present invention particularly relates to a novel method of providing the sales of immovable properties on credit or for cash by distinguishing between the bare ownership and the right of use thereof, as well as to a system wherein this method is implemented. The basic elements in this method are the immovable property, a buyer, a seller, an insurance institution, a finance institution, and an administrator of the system. Transactions between or among these elements are preferably managed by means of software, hardware and other physical means.

### BACKGROUND OF THE INVENTION

Immovable properties are one of the most significant elements of human life. Immovable properties by which humans maintain their private lives, their business lives, or in which they make investments for affording a better life, influence all humans to a more or less extent both materially and spiritually. Immovable properties are purchased or sold by some people only for housing purposes, and by some for a better life or for investment purposes. Therefore, plenty of business fields have emerged from the planning of immovable properties to the sales thereof. However, affording an immovable property is not easy for everyone. Except a very low fraction of population, many people can buy a house or a place of residence only after working for many years, or can afford it only by becoming indebted for long years. For this reason, various activities can be seen at the markets to make people buy houses. These include, inter alia, governmental credit supports, reduction of interest rates, tax exemptions and private sales methods. Many of these methods or means are intended for the pricing and sales of an immovable property, either a house or an office, taking it as a whole. In other words, many of the methods and means are designed so that the land value, the building value and the right of use of an immovable property are collectively taken into account. Therefore, immovable properties usually remain as a hard-to-reach target for most people.

Nowadays, when people afford a house as a result of working or becoming indebted for many years according to their life standards, they actually give money not only for the house only, in which they will live, but for the field and the building of the house as well. When the owner of an immovable property passes away, the property owned by the deceased is passed down to his/her successor(s) according to the law of inheritance. Therefore, people actually invest money to a material value that they will not be able to use following their death. Even if inheritance may be a solace for those in a good financial condition, the necessity to invest money to a material value which will naturally not be used after death may be considered as a material burden. For this reason, when people buy immovable either on credit or for cash, they actually buy it also for their successor(s).

The sales of immovable properties on credit is quite widespread at the present time. Accordingly, credit institutions are interested in the material values possessed by, as well as the income, age, and health conditions of those to be credited. In any case, the credits are determined taking into account the value of the respective immovable property and the risk status of the respective person to be credited for that immovable property. In this sense, for instance, younger people are deemed more eligible for crediting, whereas older people are deemed more risky in the same context. Accordingly, it becomes harder for people to afford immovable properties on credit as they get older.

Besides the mortgage credits in the sales of immovable properties, which is most popular nowadays, people can also cooperate to take possession of immovable properties. According to this system, many people come together and produce a money pool, and buy immovable properties or have constructed buildings using this pool. However, since the bare ownership and the right of use of immovable properties are valuated together in these systems, the costs emerge close to the costs of standard credits.

A method for the sales of immovable properties can be found in US2013/0103547. According to that document, a transaction method for the sales of immovable properties is described which is supported by a computer program. That system is supporting particularly in terms of real estate agents, but it seems useless for those who are to buy immovable properties in terms of the cost.

Another method for the sales of immovable properties can be found in US2012/0246013. That document describes a system which is supported by a computer program providing the generation and publication of 3D images of immovable properties to facilitate their sales. Accordingly, even if the sales of an immovable is facilitated operationally in that patent, it does provide any advantage in terms of buyers.

A further method for the sales of immovable properties can be found in US2013/0211995. That document describes a system which facilitates payments especially for buyers. Starting from a mortgage system, that system and a computer program used therein provide optimum payment options according to the value of immovable properties and the financial capability of those who are to buy them.

Therefore, it does not have an influence on the total value of the immovable property and fails to eliminate the conventional difficulties of crediting.

Another method for the sales of immovable properties can be found in WO2005/003908. That document describes a system by which basically an immovable property is valuated and is used as a financial means between buyers and sellers. Even if that system can be advantageous particularly in terms of finance institutions, it is expected that it can not be more than an investment tool for immovable buyers.

A further method for the sales of immovable properties can be found in the Turkish patent application 2011/13191. According to that document, a computer program interface is provided by which the owner of an immovable property inputs respective data related to all geographical and physical features of that immovable, and the value of that immovable is determined as a result of comparisons and calculations based on the data taken from this interface. Nothing is described there for automatic optimization calculations in terms of crediting. Neither is described there a method which relates to reducing the total price of an immovable property and provide a less expensive domicile for buyers.

Another method for the sales of immovable properties can be found in the Turkish patent application 2012/02934. That patent basically describes a system which ensures the collection of house rents for the owner of the immovable, provides immovable management services for the owner and the renter, and assumes the management of administrative and financial relations of all parties including the supplier institutions to be involved of the management services of the immovable, thereby eliminating some of the currently-faced problems. As claimed in that document, it provides a method which eliminates the costs and problems faced after an immovable is bought rather than the costs faced during the purchase of the immovable. However, it is quite far from the target of presenting housing with relatively lower costs.

### SUMMARY OF THE INVENTION

The object of the present invention is basically to generate a method, wherein during the first purchase of an immovable property, the person who is to live in that immovable does not give money to material values which the person will not need to maintain his/her life and possesses any rights of the immovable until the end of his/her life only, as well as to produce a system implementing this method.

With the method and system according to the present invention, it is desired to generate an easy and accessible trading system of immovable properties for those who do not have adequate finance to buy a house, who do not want to take great risks, or who do not want to pass their ownership down (inheritance), or even for those who do not want to give money to a good which they do not want to transfer following their death.

A feature of the method and system according to the present invention is that an immovable is valuated and sold by distinguishing between its bare ownership and its right of use. Thus, both elements, i.e. the bare ownership and the right of use, can be handled and managed separately.

Another feature of the method and system according to the present invention is that especially for those who want to buy an immovable for a living space only, they will not have to pay for the bare ownership of that immovable which is actually a material value they will not be benefiting from during their life, and therefore will own that immovable by paying only for the right of use thereof. Thus, they finally will own that immovable which otherwise they would not be able to do, and will have all rights to make disposition of that immovable.

A further feature of the method and system according to the present invention is that additional investment tools are generated for investors, as the bare ownership and the right of use of an immovable are handled, sold and managed separately. Thus, both novel investment tools are developed particularly for credit institutions, and economic activities of the respective region are increased and investors are encouraged.

Another feature of the method and system according to the present invention is that the insurance calculations required during the purchase of the right of use of an immovable on credit are made more favorable for relatively older people. The termination of the right of use following death will encourage the insurance companies to invest money into the system.

In order to provide a better understanding of the method and system according to the present invention, it shall be referred to the figures briefly described hereunder.

### BRIEF DESCRIPTION OF DRAWINGS

FIG. 1 is a diagram showing which transactions are conducted in relation to immovable properties within the method according to the present invention.

FIG. 2 is a flow chart illustrating the valuation process of the right of use in terms of the buyer of an immovable within the method according to the present invention.

FIG. 3 is a flow chart illustrating the sales and enjoyment of the right of use of an immovable within the method according to the present invention.

FIG. 4 is a diagram illustrating the conceptual design of a software-supported system for the implementation of the method according to the present invention.

### DESIGNATION OF THE PROCESS STEPS, SECTIONS AND PARTS IN THE FIGURES ILLUSTRATING THE PRESENT INVENTION

1—Immovable
   1a-Bare ownership
   1b-Right of use
   1c-Right of use in terms of the buyer
2—Owner or seller of immovable
   2a-Owner of bare ownership
   2b-Owner of right of use
3—Buyer
   3a-Life insurance rate of buyer
4—Bank
5—Insurance company
6—Managing company
7—Investing company
8—Internet or LAN
9—Server
10—Software

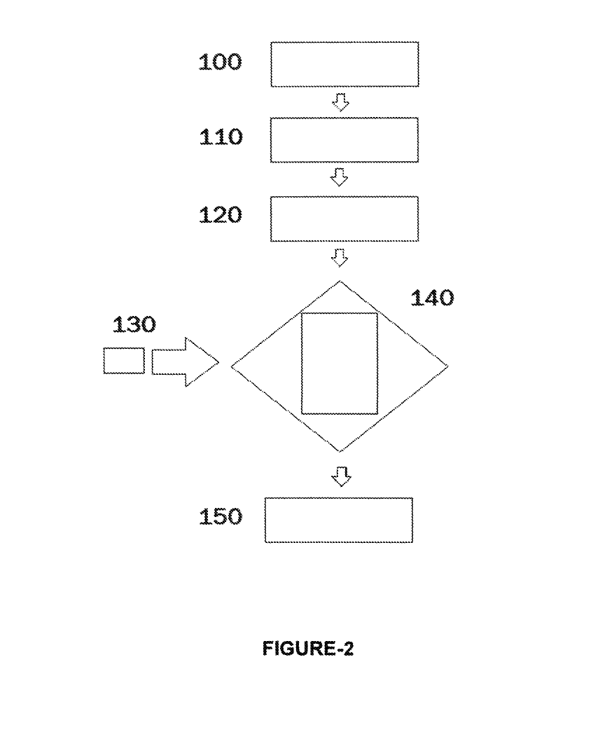

FIG. 2: Flow chart illustrating the valuation process of the right of use in terms of the buyer of an immovable
100—Start valuating the immovable
110—Calculate the value of the bare ownership of the immovable
120—Calculate the value of the right of use of the immovable
130—Include the buyer's life insurance rate
140—Compare life insurance rate and right of use and determine the value
150—Valuate the right of use to be paid by the user

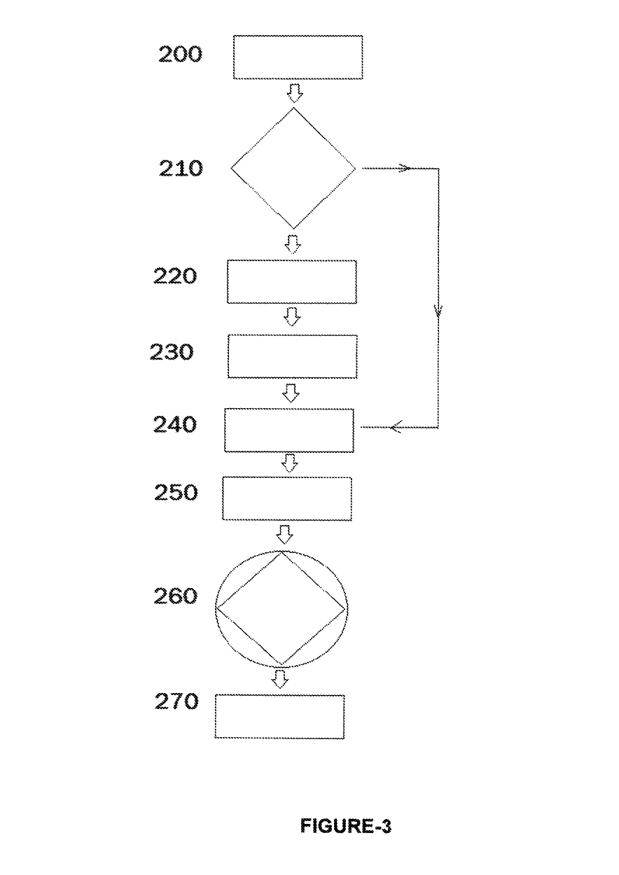

FIG. 3: Flow chart illustrating the sales and the enjoyment of the right of use of the Immovable
200—Start the sales of the right of use
210—Is the sales for cash or on credit?
220—Calculate the credit
230—Open the credit
240—Own the right of use
250—Enjoy the right of use
260—Death
270—Terminate the right of use

### DETAILED DESCRIPTION OF INVENTION

Based on the fact that the basic object of the immovable valuation and sales system according to the present invention is to distinguish between the bare ownership and the right of use of an immovable and thus to valuate and sell the bare ownership and right of use separately, in place of buying or selling the entire values of an immovable as is the conventional case, all transactions to be conducted will be based on this criterion. In order to provide a better understanding of this novel method and the system implementing this method, it will be referred to figures, flow diagrams, and computer hardware and software.

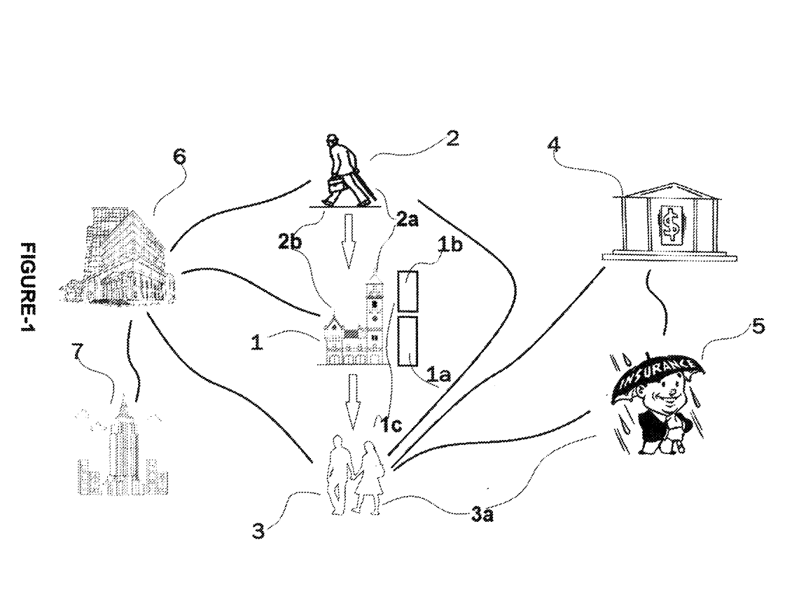

FIG. 1 illustrates the basic elements and the transactions among these basic elements required for implementing the method and system according to the present invention. Here, an immovable (1) is resolved into its bare ownership (1a) and its right of use (1b). Even if the price of an immovable (1) is calculated based on its total value on the market, actually an immovable (1) is composed of its bare ownership (1a), i.e. the value of a building which is passed down in the form of inheritance and is tangible, and of its right of use (1b), i.e. the right that cannot be passed down in the form of inheritance, but grants its owner all privileges for purchase, sales, renting, etc. Here, the right of use is not to rent, but it is the right to own the immovable restricted to the life of the owner. Therefore the system according to the present invention is based on the logic that an immovable (1) is not treated with all its rights as it is bought or sold, but only with its right of use (1b) which is of lower cost.

If the true value of an immovable (1) is e.g. 100.000 EU, the bare ownership (1a) and the right of use (1b) of that immovable (1) may be 80.000 EU and 20.000 EU, respectively. Here, the values given are not real, but it is intended here to indicate that the true value and the right of use (1b) of an immovable (1a) may be different.

Accordingly, it is clear that the owner (1) of an immovable actually possesses both the bare ownership (1a) and the right of use (1b) of the immovable (1). Normally, when a buyer (3) buys an immovable (1), the buyer pays both for the bare ownership (1a) and the right of use (1b) thereof. However, the bare ownership of the immovable (1) which the buyer (3) is to or wants to possess will or may be passed down to the beneficiary or beneficiaries of the buyer (3) following his/her death, and the right of use (1b) thereof will terminate, even if it seems to be passed down to the beneficiary or beneficiaries of the deceased. Thus, if a buyer (3) wants to buy an immovable (1) which he/she will use during his/her lifetime only, he/she will have to pay also for the bare ownership (1a) for nothing. What is aimed here with the method and system according to the present invention is a design to provide a buyer (3) with the ability to not to pay for the bare ownership (1a) to be passed down following his/her death, but to pay only for the right of use (1b) to afford that immovable (1).

With respect to FIG. 1, the owner of the immovable (1) may either be an owner (2) possessing both the bare ownership (1a) and the right of use (1b) of that immovable (1), or an owner of the bare ownership (2a) and another owner of the right of use (2b) possessing these values separately according to the method and system according to the present invention. When the owner (2) of the immovable is to sell these values, the owner may be contacted by a buyer (3). In case the buyer (3) is to buy the right of use (1b) only, it becomes necessary to calculate the right of use (1b) of that immovable (1). The money to be paid by the buyer (3) after the right of use (1b) is calculated actually correlates with the age and health condition of that buyer (3). When a sales is made for cash, the age and the health condition of the potential buyer is not taken into account. However, since the right of use (1b) is restricted to the life of the respective person, here the life insurance rate (3a) of the buyer will be effective in the calculation of the right of use (1b). The life insurance rate (3a) of the buyer is made according to the insurance calculations of the prior art. The right of use in terms of the buyer (1c) to be paid by the buyer (3) will be calculated comparing the resulting life insurance rate (3a) of the buyer to the right of use (1b). A general flow chart of this calculation is given in FIG. 2. The logic of calculating the right of use in terms of the buyer (1c) is based on that a relatively older buyer (3) will pay less than a relatively younger buyer (3) with the estimation that an older buyer (3) will die earlier than the younger buyer (3) according to average calculations, or vice versa, that a relatively younger buyer (3) will pay more than a relatively older buyer (3) with the estimation that an younger buyer (3) will die later than the older buyer (3) according to average calculations. In other words, an older person will make less use of an immovable (1) to be possessed (so that the immovable will be become free or transferred relatively sooner), whereas a younger person will make more use of that immovable (1) (so that the immovable will be become free or transferred relatively later). In fact, an immovable (1) does not have a right of use (1b) and a right of use in terms of buyer (1c) separately. It only has a bare ownership (1a) and a right of use (1b). However, in order to provide a better understanding of the method and system according to the present invention, and since the age and the estimated remaining life period of a potential buyer (3) are significant in obtaining the right of use (1b), the age and health condition, i.e. the life insurance status of the buyer will effect the right of use (1b). This, in turn, resulted in the concept of the right of use in terms of buyer (1c) influencing the bare right of use (1b).

Another point to be taken into account in the system according to the present invention with respect to a conventional life insurance calculation is that, under normal conditions, how young a person to be insured is and how late that person dies, the more advantageous will it be to the insurance company. Put differently, the insurance company will collect more insurance premium and will make the death payment relatively lately. Again, under normal conditions, how old a person to be insured is and how early that person dies, the more disadvantageous will it be to the insurance company since relatively less insurance premium will be collected. However, the right of use (1b) will not be transferred following the death of the holder of this right and a new right will be derived within the system according to the present invention. Namely, it will be profitable for the one who manages this right. Therefore, early death, which is conventionally disadvantageous for insurance companies will become an advantage here. This advantage is a further charming feature for insurance companies or for those who enjoy this right.

FIG. 2 illustrates a flow chart for obtaining the right of use in terms of the buyer (1c) besides the bare ownership (1a) and the right of use (1b) of an immovable (1). Here the basic principle is to show that when the buyer (3) intends to purchase an immovable (1) or the right of use (1b) of the immovable, many factors but primarily the age and the health condition of the buyer (3) which influences the life insurance are also effective on the right of use (1b). The calculation of the life insurance of the buyer (3) is made according to the prior art and its value may be designated as the life insurance rate (3a). When a buyer (3) is to buy an immovable (1) and the right of use (1b), the process is commenced with the step to start valuating the immovable step (100). This step is followed by the step to calculate the value of the bare ownership of the immovable (110), and then the step to calculate the value of the right of use of the immovable (120) according to the data entered into the immovable valuation system. Following this step, the right of use (1b) of the immovable (1) will not be ready to be bought by the buyer (3) and the system will ask for the life insurance rate (3a) of the buyer. With the step of including the buyer's life insurance rate (130), this data is entered. With a step of comparing the life insurance rate with the right of use and of valuating thereof (140), the system compares the immovable's right of use (1b) and the buyer's life insurance rate (3a) and makes a calculation. Following this step, the right of use in terms of the buyer (1c) to be paid by the buyer (3) for the right of use (1b) is determined through the step of valuating the right of use to be paid by the user (150). The value obtained here is the value of the right of use in terms of the buyer (1c). The calculation of this value can be made either using a computer program or manually. The significant point here is to include the life insurance rate (3a) of the buyer into the calculation. The system may be such that first the right of use (1b) is determined and then the buyer's life insurance rate (3a) is included into the calculation. The significant point here is that the potential time period during which the buyer will enjoy the right of use (1b) is estimated and thus the value of the right of use (1b) is decreased or increased accordingly.

Turning back to FIG. 1, when the buyer (3) is to buy the immovable from the owner or seller (2) of the immovable, he/she contacts an insurance company (5). The insurance company (5) will calculate the life insurance rate (3a) of the buyer. According to the system, when the buyer (3) holding the right of use (1b) dies, the right of use (1b) belonging to the immovable (1) is not passed down to the beneficiaries and is sold back as a value. Thus, the insurance company will assume the risks in these transactions. However, it has to be pointed out that if the system is designed so that no insurance company (5) is involved, but makes the calculation in relation to an early or late death of the buyer as it is made by insurance companies (5), then no insurance company (5) will be required. Another company, institution or computer program to perform the same job may complement the system. When a buyer (3) decides to purchase the right of use (1b), he/she may do this for cash or on credit. In case of credit, a bank (4) will be involved and will open the credit by calculating the buyer's life insurance rate (3a) as well. Here, the flow in which the buyer (3) buys the right of use (1b) with or without credit and enjoys this right until his/her death will be as illustrated in FIG. 3. If the buyer (3) buys the right of use (1b) of an immovable directly from the seller or through other ways to be described below, the system will commence with the step to start the sales of the right of use (200). The buyer (3) is asked if he/she makes the purchase for cash or on credit in step (210) and it is responded accordingly. If the buyer (3) will make the purchase on credit, he/she will agree with the bank (4) so that the amount of credit is calculated taking into account the life insurance rate (3a) of the buyer in the step to calculate the credit (220). With the step to open the credit (230), the credit is given to the buyer (3) and thus to the seller (2). The next step is the step to own the right of use (240). Meanwhile, if another company, institution or computer program is used in place of the bank to manage the credit and finance transactions, there will be no need to use a bank (4) in the system either. If the buyer (3) decides to buy the right of use (1b) for cash, he/she directly works with an insurance company (5) without contacting a bank (4) and may obtain the right of use (1b) of the immovable by becoming insured. Thus, the step to own the right of use (240) may be started. In this step, the buyer becomes the owner of the right of use in accordance with applicable laws and may enjoy the right of use (1b) until his/her death. Now, the buyer (3) becomes the owner of a new immovable (2) and may use it as he/she wishes. This is the step to enjoy the right of use (250). When the buyer (3) dies as he/she enjoys the right of use (1b), the step of death (260) takes place. If the buyer (3) only possesses the right of use of immovable (1), the right of use (1b) terminates. If the buyer (3) possesses the bare ownership (1a) at the same time, the bare ownership (1a) may be passed down through inheritance. In both cases, the right of use (1b) is terminated with the step to terminate the right of use (270) and a new phase emerges to sell the right of use (1b). The sales of the right of use (1b) may be conducted separately or together with the bare ownership (1a).

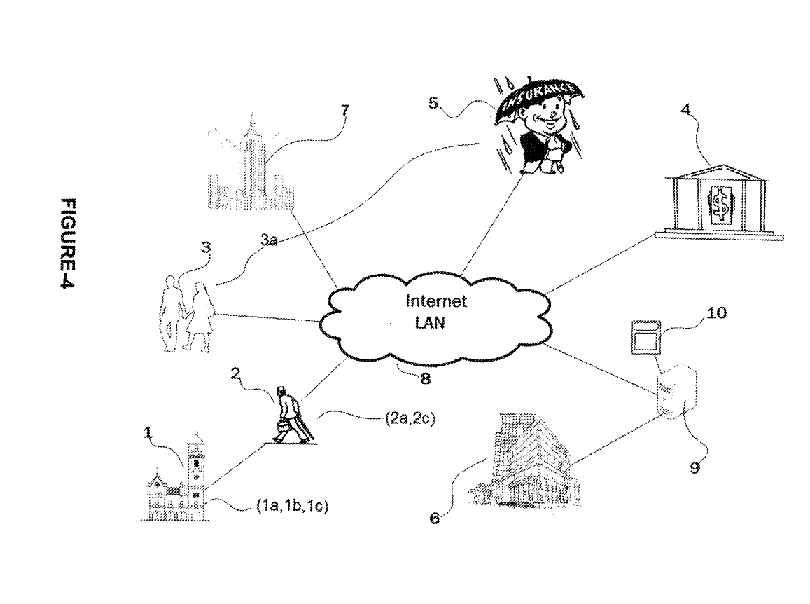

The management of all transactions, including the sales and purchase transactions in relation to the immovable (1) and primarily the right of use (1b) thereof and the management of the relations with the banks and insurance companies are performed by a managing company (6). The managing company (6) may purchase (or sell) an immovable (1) from the owner or seller (2) (or to a buyer) thereof according to agreements made based both on bare ownership (1a) and right of use (1b). Since the managing company (6) is an entity regulating the system, this job can optionally be performed by a computer program. The investing companies (7) may invest only in bare ownership (1a) or in the right of use (1b). Here, what is meant with the term investing company (7) is a company, person or funds investing in the bare ownership (1a), the right of use (1b) or in both of them. The owners or sellers (2) and the buyers (3) of the immovable may desire the whole of an immovable (1) or only the bare ownership (1a) or right of use (1b) thereof. All these transactions are conducted via legal acts. In order to conduct all these transactions in a correct manner, a software-supported system shown in FIG. 4 can be used. Here the basic elements are an immovable (1), bare ownership (1a) and right of use (1b) of the immovable, owner or seller (2) of the immovable, buyer (3), bank (4), insurance company (5), investing company (7), managing company (6), and Internet or LAN connection (8) providing the communication between these elements. The LAN connection may either be a direct wire or wireless connection, or another type of a communication system. Since the manager of the system is the managing company (6), data related to the system are kept on a server (9) by means of a software (10). Here, the technical infrastructure of the system and the features of the software will not be described. However, the management of the system is distributed from the server (9) for use by others (buyer, seller, bank, insurance company etc.) by means of the managing company (6) using the software (10), internet and LAN (8). The management of the system can be performed by the company or another party by means of the software (10).

An immovable (1) may become the subject of transactions within the method and system according to the present invention either by its bare ownership (1a) or right of use (1b) or both of them. These transactions may be any kind of purchase, sales, issuing bonds, and similar derivatives thereof. Thus, under normal conditions, a buyer (3) who may buy an immovable (1) only with difficulty can purchase only the right of use (1b) thereof and may enjoy this right until the end of his/her life. If necessary, this right of use (1b) may be transferred provided that the respective conditions are met. In this case, the right of use will be recalculated according to the new buyer. If the buyer desires and becomes able to pass down the immovable through inheritance, he/she may also buy the bare ownership (1a) to own the whole of the immovable. In this case, the owners of immovable properties (2) can be divided into two as the owners of the bare ownership (2a) and the owners of the right of use (2b) and the transactions may be performed accordingly. The owner of an immovable (2) may possess both the bare ownership (2a) and its right of use (2b) at the same time. The investors may invest in, sell or transfer the bare ownerships (1a) of immovable properties. All these transactions will result in economic activities which will provide a completely separate added value and in economic recovery.

The method according to the present invention and a system based on this method may be managed as described above based on a computer program and hardware providing communication and may be applied to any kind of immovable properties. Any kind of immovable properties and primarily houses, but also plants, storehouses, airports, etc. may be covered.

1. A valuation and sales system for immovable properties, comprising:
at least one immovable property and at least one bare ownership and at least one right of use of said immovable property;
at least one immovable owner or seller to sell his/her immovable property;
at least one buyer to buy the immovable property or the right of use thereof, as well as a life insurance rate of said buyer;
at least one insurance company providing the life insurance rate of said buyer, or an another company, institution or computer program performing this transaction;
at least one bank providing credit to said buyer in sales on credit, or an another company, institution or computer program performing this transaction;
at least one managing company managing said buyer, owner or seller of the immovable property, the bank, the insurance company, and the bare ownership and the right of use of said immovable property, or a computer program performing this transaction;
at least one investor in connection with said managing company, bank, insurance company, owner or seller of the immovable property, the buyer and the bare ownership and the right of use of said immovable property;
a software by which said system is managed by the managing company or an another party, at least one server where said software is located, and at least one Internet or LAN connection through which the system is distributed from said server.

2. The system according to claim 1, wherein the life insurance rate increases or decreases the value of the right of use, and the right of use in terms of a respective user is obtained according to said life insurance rate.

3. The system according to claim 1, wherein for obtaining the right of use in terms of the specific buyer, the system is configured to
valuate the immovable property,
calculate the value of the bare ownership of the immovable property,
calculate the value of the right of use of the immovable property,
include the buyer's life insurance rate into the system,
compare the life insurance rate and the right of use and determine the value, and
valuate the right of use to be paid by the user.

4. A method for a buyer to buy and enjoy a right of use of an immovable property, the method comprising:
starting a sale of the right of use;
deciding if the sales is for cash or on credit;
calculating a credit if the sale is on credit;
opening the credit;
owning the right of use;
enjoying the right of use; and
terminating the right of use on death of the buyer.

5. A valuation and sales system for immovable properties comprising an immovable property, bare ownership and a right of use of the immovable property, at least one owner or seller of the immovable property, at least one buyer, at least one bank, at least one insurance company, at least one investing company, at least one managing company, and at least one Internet or LAN connection providing communication between them, at least one server in communication with said Internet or LAN connection, and a software located on said server and managing the system.

6. The system according to claim 2, wherein for obtaining the right of use in terms of the specific buyer, the system is configured to
valuate the immovable property,
calculate the value of the bare ownership of the immovable property,
calculate the value of the right of use of the immovable property,
include the buyer's life insurance rate into the system,
compare the life insurance rate and the right of use and determine the value, and
valuate the right of use to be paid by the user.
